(19) United States
(12) Patent Application Publication
(10) Pub. No.: US 2025/0171290 A1
(43) Pub. Date: May 29, 2025

(54) METHOD AND APPARATUS FOR CONTROLLING THE DOSING OF A FLUID PRODUCT TO CONTAINERS

(71) Applicant: GEA PROCOMAC S.p.A, SALA BAGANZA (Parma) (IT)

(72) Inventor: Michele Maffini, Fidenza (Parma) (IT)

(73) Assignee: GEA PROCOMAC S.p.A., SALA BAGANZA (Parma) (IT)

(21) Appl. No.: 18/955,018

(22) Filed: Nov. 21, 2024

(30) Foreign Application Priority Data
Nov. 28, 2023 (IT) 102023000025302

(51) Int. Cl. B67C 3/28

(52) U.S. Cl. CPC B67C 3/287; B67C 3/286

(57) ABSTRACT

A method (200) for controlling the dosing of a fluid product to containers (105) using an apparatus (100) including a plurality of filling valves (104), the method (200) comprising performing a cycle having the following steps for each filling valve (104):
ending an opening command to the filling valve (104);
detecting values of volume of the fluid product dispensed by the filling valve (104) and values of flowrate, occurring at a predefined sampling interval;
calculating a compensated volume (CV) as the difference between a target volume (TV) to be dispensed to the container (105) and a volumetric filling error (E) detected at the immediately previous filling step;
determining a compensated closing time (CCT) as the time at which sending a closing command to the filling valve (104);
sending the closing command to the filling valve (104) at the compensated closing time (CCT);
after having closed the filling valve (104), receiving a detected value of volumetric filling error (E2, E3, E4, E5).

The present invention relates to a method and apparatus for controlling the dosing of a fluid product to containers.

The invention proposed here is applicable in the food industry, in particular in the bottling sector, or in the chemical, pharmaceutical or cosmetic industry.

The medium to be filled is usually a liquid, such as a beverage optionally containing solid pieces (i.e. fruit, nuts, or the like), or also a liquid that is not food, such as mineral oil or the like.

During the filling process it is necessary to fill containers with a reliable and repeatable throughput.

There are known several approaches in the prior art to determine the filled quantity with a sensor. A scale can be used to directly determine the filled mass, but weighing is not well suited for fast processes, as the movement of the filling machine causes vibrations that limit the accuracy of filling.

A height gauge or level measurement may be used to determine the filling height. However, variances in the containers result in an error in the filling quantity.

In addition, closing filling valves involves a transient time. Indeed, upon receiving a closing command, the actual closing time for a filling valve may fluctuate over time.

In fact, filling valves are not ideal systems for many reasons. There could be pneumatic and/or physical differences among the filling valves of a filling machine. In addition, viscosity and temperature of the fluid product, as well as time variation thereof can influence the closing time.

Furthermore, the electronic control also introduces transient time in closing the filling valves.

From document DE102005008041 it is known a method for the metered filling of a flowable medium into containers with a metering valve integrated in a filling pipeline. The solution is based on a flowmeter also integrated in the filling pipeline for detecting the volume flow of flowable medium passing through the filling pipeline. The measured value is made available to an electronic control unit which actuates the metering valve in a clocked manner on the basis of a stored desired filling quantity.

In another solution disclosed in document DE 102005035264 B4 the flowrate is determined with a neural network. The neural network can only evaluate the measurement data it receives, so that measurement errors for the flowrate still leads to inaccuracies in the filled quantity.

In this context, the object of the present invention is to provide a method and apparatus for controlling the dosing of a fluid product to containers, which overcome the problems of the prior art cited above.

In particular, the object of the present invention is to propose a method and apparatus for controlling the dosing of a fluid product to containers, which provide a more accurate control of filling.

The stated technical task and specified aims are substantially achieved by a method for controlling the dosing of a fluid product to containers using an apparatus comprising a plurality of filling valves, the method comprising performing a cycle having the following steps for each filling valve:
sending an opening command to the filling valve so that the filling valve performs a filling of the corresponding container with the fluid product;
detecting values of volume of the fluid product dispensed by the filling valve and values of flowrate, said detecting occurring at a predefined sampling interval;
calculating a compensated volume as the difference between a target volume to be dispensed to said container and a volumetric filling error detected at the immediately previous filling step or obtained by linear interpolation of points on a plane where y-axis is the volumetric filling error and y-axis is the detected flowrate;
determining a compensated closing time as the time at which sending a closing command to the filling valve, the compensated closing time being the time at which the detected value of volume that has been dispensed reaches said compensated volume;
sending the closing command to the filling valve at the compensated closing time;
after having closed the filling valve, receiving a detected value of volumetric filling error, the last value of flowrate detected before the compensated closing time and the detected value of volumetric filling error being coordinates of a further point on said plane.

According to an embodiment of the invention, the method further comprises the following steps before performing said cycle:
initializing the volumetric filling error on the plane at an initial volumetric error;
sending an opening command to the filling valve so that the filling valve performs a first filling of the corresponding container with the fluid product;
detecting values of volume of the fluid product dispensed by the filling valve and values of flowrate, said detecting occurring at said predefined sampling interval;
calculating a first compensated volume as the difference between a target volume to be dispensed to said container and the initial volumetric filling error;
determining a first compensated closing time as the time at which sending a closing command to the filling valve, the first compensated closing time being the time at which the detected value of volume that has been dispensed reaches said first compensated volume;
sending the closing command to the filling valve at the first compensated closing time;
after having closed the filling valve, receiving a first detected value of volumetric filling error, the last value of flowrate detected before the first compensated closing time and the first detected value of volumetric filling error being coordinates of a further point on said plane.

Preferably, at each filling of the cycle the last values of flowrate detected before the compensated closing time and detected values of volumetric filling error are used to update an error curve on said plane, that is a polygonal curve connecting the detected points so far.

According to one aspect of the invention, the step of initializing the volumetric filling error takes place after changing the format of the containers and/or after changing the fluid product.

Preferably, the step of initializing is different from one of the filling valves which is the first filling valve to be opened. The remaining filling valves using the first detected value of volumetric error of the first filling valve as the initial volumetric error for the step of initializing.

According to a preferred embodiment, the predefined sampling interval is comprised between 1 and 10 microseconds.

More preferably, the predefined sampling interval is comprised between 4 and 6 microseconds.

The stated technical task and specified aims are substantially achieved by an apparatus for dosing a fluid product to containers, said apparatus comprising:
a tank for the fluid product;
a plurality of filling stations, each equipped with a filling device in selective communication with the tank, each filling device comprising a filling valve and a flowmeter;
a control unit which, in response to receiving measure values from the flowmeters, is configured to carry out the method according to the present invention.

According to a preferred embodiment, the apparatus further comprises a memory configured to store an archive of set points for the filling valves. The control unit is configured to receive also the setpoints from the memory. Further characteristics and advantages of the present invention will more fully emerge from the non-limiting description of a preferred but not exclusive embodiment of a method and apparatus for controlling the dosing of a fluid product to containers, as illustrated in the accompanying drawings in which:

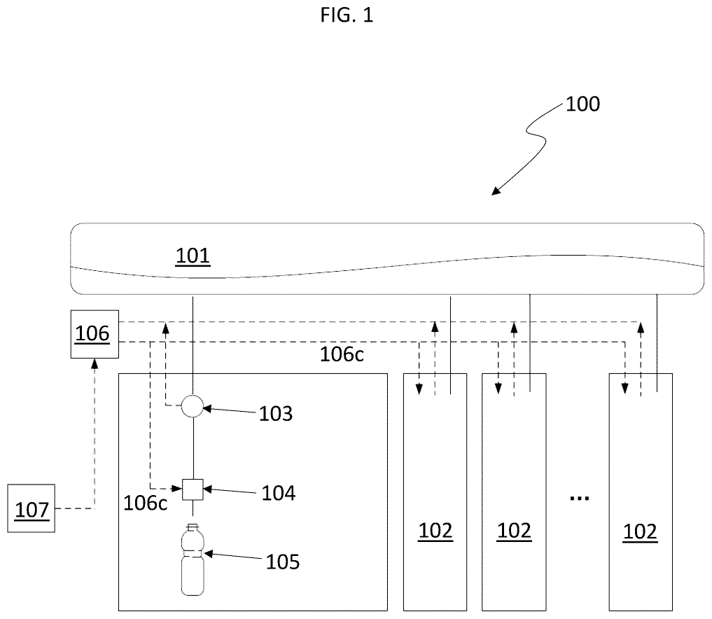

FIG. 1 is a schematic view of an apparatus for filling containers, according to the present invention;

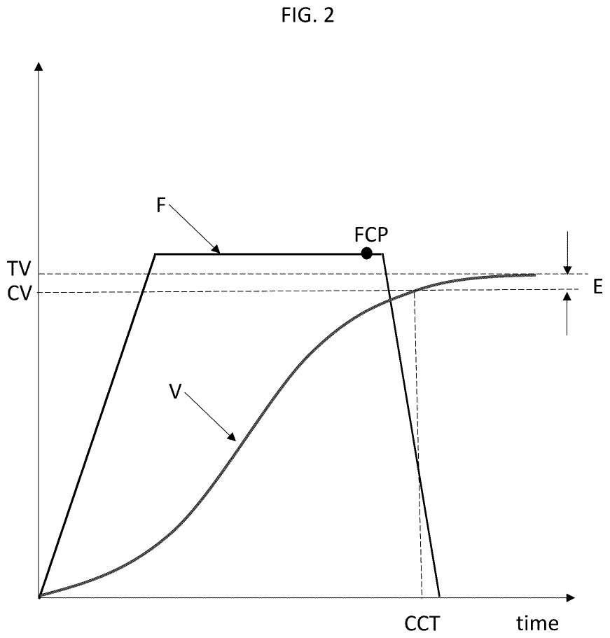

FIG. 2 illustrates the filling flowrate and the filled volume over time for a filling valve of the apparatus of FIG. 1 using a method for controlling the dosing of a fluid product to containers, according to the present invention;

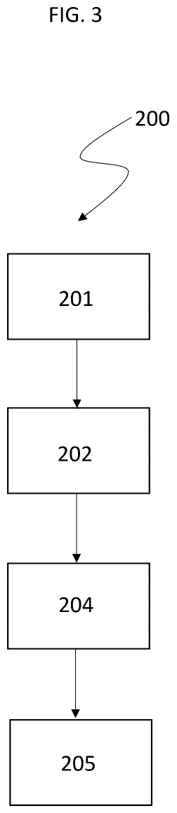

FIG. 3 illustrates the flow diagram of a method for controlling the dosing of a fluid product to containers, according to the present invention;

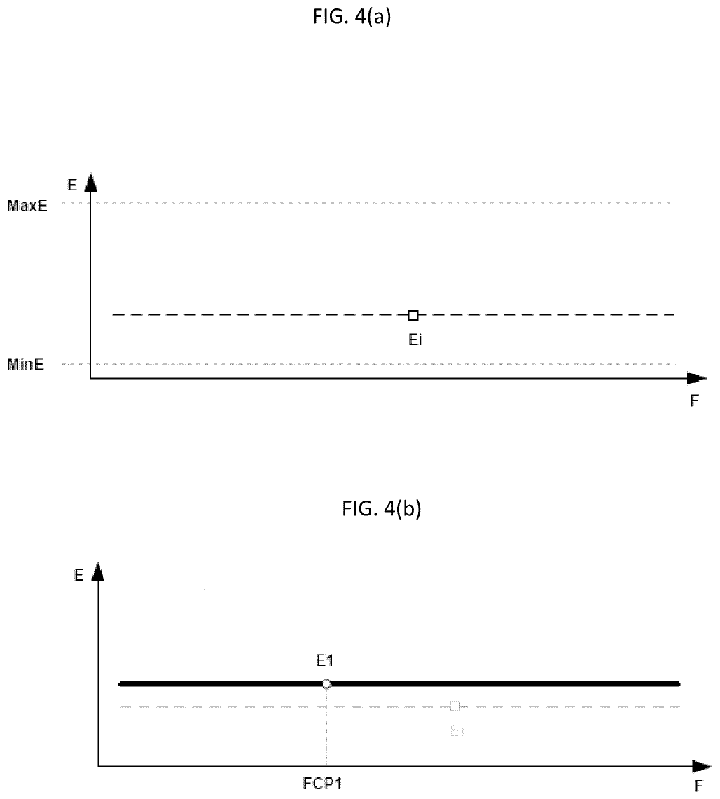

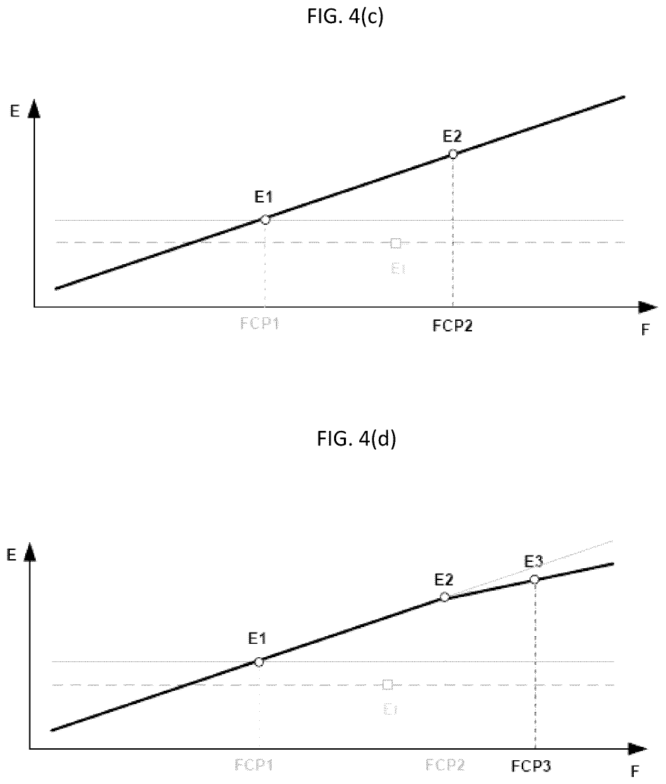

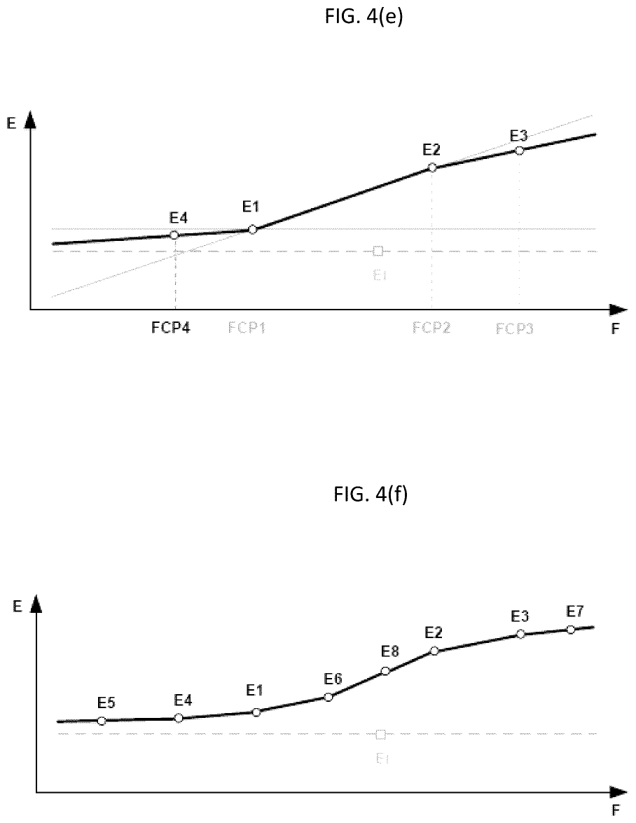

FIG. 4(a) illustrates the error curve at a step of the method of FIG. 3;

FIG. 4(b) illustrates the error curve at a step of the method of FIG. 3;

FIG. 4(c) illustrates the error curve at a step of the method of FIG. 3;

FIG. 4(d) illustrates the error curve at a step of the method of FIG. 3;

FIG. 4(e) illustrates the error curve at a step of the method of FIG. 3; and

FIG. 4(f) illustrates the error curve at a step of the method of FIG. 3.

With reference to the drawings, number 100 denotes an apparatus for dosing a fluid product to containers 105, for example a beverage.

The apparatus 100 comprises a plurality of filling stations 102, each equipped with a filling device.

Each filling device comprises a filling valve 104 for dispensing the fluid product to a corresponding container 105 located below.

Each filling station 102 also comprises a flowmeter 103 that is operatively active on the filling device for measuring the amount of fluid product that has flowed through the corresponding filling valve 104.

The apparatus 100 comprises a tank 101 for the fluid product to be supplied to the filling devices via valve means. In fact, the filling devices are in selective fluid communication with the tank 101 so as to receive the fluid product during the filling process.

The filling valves 104 are part of the valve means of the filling apparatus 100.

The filling valves 104 may be actuated either by a pneumatic or magnetic or electric or electromagnetic control.

In a filling status of the apparatus 100, the filling valves 104 are in an open configuration to enable the fluid product to pass through the filling devices and be dispensed into the containers 105.

The apparatus 100 comprises a control unit 106 operatively active on the filling valves 104 to control the dispensing of fluid product into the containers 105.

The control unit 106 is configured to receive measure values from the flowmeters 103 of the filling stations 102 and, in response to them and based on filling valve setpoints, is configured to generate filling valve control signals 106c that are sent to the filling valves 104.

In this context, a filling valve set point (shortly “set point”) is the desired volume dispensed by said filling valve. The apparatus 100 comprises a memory 107 that is configured to store an archive of set points. Preferably, each set point of the archive of set points has been previously mapped depending on one or more of the following features: type of fluid product, type and capacity of containers to be filled.

According to an embodiment, the apparatus 100 is of the rotating carousel type. The filling stations 102, with the relative filling devices, are thus distributed along a circumferential extension of the rotating carousel.

According to another embodiment, the apparatus 100 is of the linear type.

The proposed invention has been developed starting from the observation of the behaviour of a filling valve 104 during a filling process.

For merely illustrative purposes, reference is made to FIG. 2, illustrating two superimposed curves over time for a filling valve 104:
a first curve representing the filling flowrate F;
a second curve representing the filled volume V.

It must be pointed out the first curve is a simplified example. In fact, there exist filling valves having a filling flowrate F with a more complex curve plot, in particular with a filling step at high speed and then a filling step at low speed before closing.

Opening and closing of the filling valve 104 is governed by the control unit 106. In particular, the control unit 106 is configured to send a filling valve control signal 106c that may be set to an opening value (or command) or to a closing value (or command).

When the filling valve 104 receives an opening command, it is forced to open so that the filling flowrate F increases. The filling valve 104 starts dispensing the fluid product to the corresponding container 105 with a filling flowrate F, for example according to the first curve of FIG. 2.

During the filling process, the flowmeter 103 continuously detects the filling flowrate F for the filling valve 104. More precisely, the flowmeter 103 detects the volume of fluid product dispensed by the filling valve 104 and provides as output a derived measure, which is the filling flowrate F.

Theoretically, in response to the dispensed volume reaching a predefined set point, the control unit 106 should send a closing command to the filling valve 104.

In this context, it is remarked that a predefined set point for a filling valve is the desired volume dispensed by said filling valve.

Ideally, the filling valve 104 should instantaneously close upon receiving the closing command, with a theoretical filled volume dispensed into the container 105. In this context, the theoretical filled volume is also referenced to as “target volume” and is indicated as TV.

Nevertheless, as already said, the filling valve 104 does not close instantaneously upon receiving the closing command due to electronic signal delay and mechanical friction. By contrast, there exists a delay between the closing command and the actual closing time of the filling valve 104.

This delay causes the filling valve 104 to continue dispensing a certain amount of fluid product in excess with respect to the theoretical filled volume TV. The fluid product dispensed in excess is addressed here as “volumetric filling error”, referenced as E. This error E is a function of the flowrate.

In order to avoid or reduce the volumetric filling error E for a filling valve 104, it is envisaged to send in advance the closing command to the filling valve 104.

In fact, it is desirable to send the closing command to the filling valve 104 sufficiently in advance so that the filling valve 104 actually closes when the filled volume dispensed to the container 105 is indeed the theoretical filled volume or target volume TV, as shown in the second curve of FIG. 2. Accordingly, the closing command should occur when the dispensed volume is TV−E, so that the actual delay in closing the filling valve 104 allows to reach the theoretical filled volume or target volume TV.

It is defined here a volume CV=TV−E, called “compensated volume”, which is the volume at a time referred to as compensated closing time CCT. The compensated closing time CCT is indeed the time at which sending a closing command to the filling valve 104 so that the volume dispensed into the container 105 reaches the target volume TV.

Indeed, the filling valve 104 is ordered to close at the time (which is the compensated closing time CCT) determined for compensating the volumetric filling error E (which is an error in volume).

In other words, closing the filling valve 104 at the compensated closing time CCT allows to reach a dispensed volume which is the target volume TV due to the inertia of the apparatus, which indeed generates an error (the volumetric filling error E).

As an example, it is assumed a target volume TV of 1000 ml to be dispensed in the container 105, and it is known there is a volumetric filling error E of 5 ml introduced by the inertia of the apparatus.

Closing the filling valve 104 at the target volume TV would result in dispensing an actual volume of 1005 ml due to the volumetric filling error E. With the proposed method, the filling valve 104 is ordered to close in advance, i.e. immediately before the compensated volume CV is reached, which is CV=TV−E=1000 ml−5 ml=995 ml.

The flowrate F is continuously detected by the flowmeter 103. In this context, the expression “continuously detection” means performing a detection with at a sampling interval in the range from 1 to 10 microseconds. More preferably, the sampling interval is in the range from 4 to 6 microseconds.

The flowrate corresponding to the compensated volume CV, indicated as “flowrate at closing point” or FCP is the last sampled value, which means the value of flowrate sampled before the compensated closing time CCT. In other words, the flowrate at closing point FCP is the value of flowrate detected by the flowmeter 103 immediately before the compensated closing time CCT. In this context, the expression “immediately before” means that the value is the sample detected before the compensated closing time CCT. With reference to FIG. 3, number 200 denotes a method for controlling the dosing of a fluid product to the containers 105 using the filling valves 104. The method 200 comprises determining an error curve for each filling valve 104, where the error curve is a characteristic curve of a volumetric filling error E as a function of a filling flowrate F for the filling valve 104.

At each filling step, the flowrate at closing point (FCP) as well as the volumetric filling error E detected at the closing time may fluctuate for the same filling valve 104. These values indeed fluctuate across the filling steps. Thus, the error curve represents the volume deviation originated by the fluctuation of the flowrate, due to non-ideality of the filling valve 104 and delays introduced by the electronics of the control unit 106.

FIGS. 4(a) to 4(f) shows a plane (E, F) at different steps of the method 200, where the y-axis of the plane (E, F) represents the volumetric filling error E expressed in ml, and the x-axis represents the filling flowrate F expressed in ml/s.

According to an aspect of the invention, the method 200 starts with a step of initializing the error curve, indicated with 201 and shown in FIG. 4(a). The error curve is initialized with a constant straight line according to the following equation:

$$E ( F ) = Ei \qquad ( 1.1 )$$

where Ei is an initial volumetric filling error comprised between a minimum acceptable error (referred to as MinE) and a maximum acceptable error (referred to as MaxE).

The initial volumetric filling error Ei is a predefined value established after previous tests on the specific fluid product.

In particular, the step of initializing the error curve 201 takes place after changing the container format and/or after changing the fluid product.

The method 200 then proceeds with a first filling step, indicated with 202. During the first filling step 202, assuming the initial volumetric filling error Ei, the control unit 106 is configured to send a closing command to the filling valve 104 at a time for which the detected volume of fluid product that has been dispensed reaches a compensated volume that is CV=TV−Ei.

As said, volume and flowrate of the fluid product dispensed by the filling valve 104 are continuously detected, meaning they are detected with a sampling interval comprised in the range from 1 to 10 microseconds. The first value of flowrate at closing point is therefore the last value of flowrate sampled before the time at which the compensated volume reaches CV=TV−Ei.

The first value of flowrate at closing point is referenced to as FCP1 and shown in FIG. 4(b).

After having closed the filling valve 104, a first value of volumetric filling error E1 is detected, which takes the place of the initial volumetric filling error Ei.

Therefore, the error curve at the first filling step 202 becomes a constant straight line according to the following equation:

$$E ( F ) = E 1 \qquad ( 1.2 )$$

Said error curve is shown in FIG. 4(b).

The method 200 proceeds with a second filling step, indicated with 204. During the second filling step 204, the control unit 106 is configured to send a closing command to the filling valve 104 at a time (compensated closing time CCT) at which the detected volume of fluid product that has been dispensed reaches a compensated volume that is CV=TV-E1.

Immediately before the compensated time CCT, a second value of flowrate at closing point FCP2 is detected by the correspondent flowmeter 103 and saved. The second value of flowrate at closing point FCP2 is the value of flowrate sampled before the time at which the compensated volume reaches CV=TV−E1.

After the filling valve 104 has closed, a second value of volumetric filling error E2 is detected.

Thus, at the second filling step 204 the error curve becomes a straight line passing through the two points having coordinates (FCP1, E1) and (FCP2, E2), as illustrated in FIG. 4(c).

The method 200 comprises further filling steps, indicated with 205. During the further filling steps 205, further values of flowrates at closing point (namely FCP3, FCP4) are detected immediately before the corresponding compensated closing times, and further values of volumetric filling errors E3, E4, E5, . . . , E8 are detected after the filling valve 104 has been closed. At each filling step, the flowrate is measured by the flowmeter 103 at a closing time corresponding to a volumetric filling error predicted by linear interpolation. Then, the volumetric filling error is actually measured and is used to update the curve.

In practice, at each filling step the error curve is updated by a further pair of detected values of filling flowrate and volumetric filling error. Identification of further pairs of detected values of filling flowrates and volumetric filling errors serves for obtaining a more precise characterization of the error curve.

Preferably, the error curve is a polygonal curve connecting the measurement points.

This is shown in FIGS. 4(d) to 4(f).

When it is retrieved a volumetric filling error which is already mapped in the error curve by linear interpolation, the already mapped volumetric filling error is substituted with the second to last volumetric filling error.

For the sake of comprehension, the method 200 has been described so far for a single filling valve 104.

According to an embodiment of the invention, all the filling valves 104 adopt the same method 200.

According to another embodiment of the invention, the initial volumetric filling error of the filling valves 104 other than the first filling valve that was opened is set at the first volumetric filling error E1 of the first filling valve 104 that was opened.

The error curve is continuously updated by obtaining points during successive filling steps overall the functioning of the apparatus 100. This allows to have an error curve which is dynamically adapted to the actual process over time, instead of using a static predefined curve.

The characteristics and the advantages of a method and apparatus for controlling the dosing of a fluid product to containers, according to the present invention, are clear, as are the advantages.

The method allows to achieve more repeatability in filling the containers than previous solutions. As a matter of fact, predicting the volumetric filling errors for the filling valves allows to send in advance the closing commands to the filling valves so as to get nearer to the target volume over the whole filling process.

1. A method (200) for controlling the dosing of a fluid product to containers (105) using an apparatus (100) comprising a plurality of filling valves (104), the method (200) comprising performing a cycle having the following steps for each filling valve (104):
sending an opening command to the filling valve (104) so that the filling valve (104) performs a filling (204, 205) of the corresponding container (105) with the fluid product;
detecting values of volume of the fluid product dispensed by the filling valve (104) and values of flowrate, said detecting occurring at a predefined sampling interval;
calculating a compensated volume (CV) as the difference between a target volume (TV) to be dispensed to said container (105) and a volumetric filling error (E) detected at the immediately previous filling step or obtained by linear interpolation of points on a plane (E, F) where y-axis is the volumetric filling error (E) and y-axis is the detected flowrate (F);
determining a compensated closing time (CCT) as the time at which sending a closing command to the filling valve (104), the compensated closing time (CCT) being the time at which the detected value of volume that has been dispensed reaches said compensated volume (CV);
sending the closing command to the filling valve (104) at the compensated closing time (CCT);
after having closed the filling valve (104), receiving a detected value of volumetric filling error (E2, E3, E4, E5), the last value of flowrate (FCP2, FCP3, FCP4) detected before the compensated closing time (CCT) and the detected value of volumetric filling error (E2, E3, E4, E5) being coordinates of a further point on said plane (E, F).

2. The method (200) of claim 1, further comprising the following steps before performing said cycle:
initializing (201) the volumetric filling error (E) on the plane (E, F) at an initial volumetric error (Ei);
sending an opening command to the filling valve (104) so that the filling valve (104) performs a first filling (202) of the corresponding container (105) with the fluid product;
detecting values of volume of the fluid product dispensed by the filling valve (104) and values of flowrate, said detecting occurring at said predefined sampling interval;
calculating a first compensated volume (CV) as the difference between a target volume (TV) to be dispensed to said container (105) and the initial volumetric filling error (Ei);
determining a first compensated closing time (CCT) as the time at which sending a closing command to the filling valve (104), the first compensated closing time (CCT) being the time at which the detected value of volume that has been dispensed reaches said first compensated volume (CV);
sending the closing command to the filling valve (104) at the first compensated closing time (CCT);
after having closed the filling valve (104), receiving a first detected value of volumetric filling error (E1), the last value of flowrate (FCP1) detected before the first compensated closing time (CCT) and the first detected value of volumetric filling error (E1) being coordinates of a further point on said plane (E, F).

3. The method (200) of claim 2, wherein the step of initializing (201) the volumetric filling error (201) takes place after changing the format of the containers and/or after changing the fluid product.

4. The method (200) of claim 1, wherein at each filling of said cycle the last values of flowrate (FCP2, FCP3, FCP4) detected before the compensated closing time (CCT) and detected values of volumetric filling error (E2, E3, E4, E5) are used to update an error curve on said plane (E, F), that is a polygonal curve connecting the detected points so far.

5. The method (200) of claim 2 or 3, wherein the step of initializing (201) is different from one of the filling valves (104) which is the first filling valve (104) to be opened, the remaining filling valves (104) using the first detected value of volumetric error (E1) of the first filling valve (104) as the initial volumetric error (Ei) for the step of initializing (201).

6. The method (200) of claim 1, wherein said predefined sampling interval is comprised between 1 and 10 microseconds.

7. The method (200) of claim 6, wherein said predefined sampling interval is comprised between 4 and 6 microseconds.

8. An apparatus (100) for dosing a fluid product to containers (105), said apparatus (100) comprising:
a tank (101) for the fluid product;
a plurality of filling stations (102), each equipped with a filling device in selective communication with the tank (101), each filling device comprising a filling valve (104) and a flowmeter (103);
a control unit (106) which, in response to receiving measure values from the flowmeters (103), is configured to carry out the method (200) according to claim 1.

9. The apparatus (100) according to claim 8, further comprising a memory (107) configured to store an archive of set points for the filling valves (104), said control unit (106) being configured to receive also the setpoints from the memory (107).

10. Computer program having instructions which, when executed by a computer device or system, cause the computing device or system to perform the method according to claim 1.

11. The method (200) of claim 2, wherein at each filling of said cycle the last values of flowrate (FCP2, FCP3, FCP4) detected before the compensated closing time (CCT) and detected values of volumetric filling error (E2, E3, E4, E5) are used to update an error curve on said plane (E, F), that is a polygonal curve connecting the detected points so far.

12. The method (200) of claim 3, wherein at each filling of said cycle the last values of flowrate (FCP2, FCP3, FCP4) detected before the compensated closing time (CCT) and detected values of volumetric filling error (E2, E3, E4, E5) are used to update an error curve on said plane (E, F), that is a polygonal curve connecting the detected points so far.

13. The method (200) of claim 3, wherein the step of initializing (201) is different from one of the filling valves (104) which is the first filling valve (104) to be opened, the remaining filling valves (104) using the first detected value of volumetric error (E1) of the first filling valve (104) as the initial volumetric error (Ei) for the step of initializing (201).

14. The method (200) of claim 2, wherein said predefined sampling interval is comprised between 1 and 10 microseconds.

15. The method (200) of claim 3, wherein said predefined sampling interval is comprised between 1 and 10 microseconds.

16. The method (200) of claim 4, wherein said predefined sampling interval is comprised between 1 and 10 microseconds.

17. The method (200) of claim 5, wherein said predefined sampling interval is comprised between 1 and 10 microseconds.

18. An apparatus (100) for dosing a fluid product to containers (105), said apparatus (100) comprising:
a tank (101) for the fluid product;
a plurality of filling stations (102), each equipped with a filling device in selective communication with the tank (101), each filling device comprising a filling valve (104) and a flowmeter (103);
a control unit (106) which, in response to receiving measure values from the flowmeters (103), is configured to carry out the method (200) according to claim 2.

19. An apparatus (100) for dosing a fluid product to containers (105), said apparatus (100) comprising:
a tank (101) for the fluid product;
a plurality of filling stations (102), each equipped with a filling device in selective communication with the tank (101), each filling device comprising a filling valve (104) and a flowmeter (103);
a control unit (106) which, in response to receiving measure values from the flowmeters (103), is configured to carry out the method (200) according to claim 3.

20. Computer program having instructions which, when executed by a computer device or system, cause the computing device or system to perform the method according to claim 2.
